(19) United States
(12) Patent Application Publication
(10) Pub. No.: US 2022/0223940 A1
(43) Pub. Date: Jul. 14, 2022

(54) Porous Endothermic Article

(71) Applicant: Thermal Ceramics, Inc., Augusta, GA (US)

(72) Inventors: Gilbert Carrasquillo, Augusta, GA (US); Michael Cohn, Augusta, GA (US); Gary Gayman, Augusta, GA (US); Jensen Plummer, Augusta, GA (US); Jason Street, Augusta, GA (US)

(73) Assignee: Thermal Ceramics, Inc., Augusta, GA (US)

(21) Appl. No.: 17/603,992

(22) PCT Filed: Dec. 12, 2019
(86) PCT No.: PCT/EP2019/084984

§ 371 Date: Oct. 15, 2021

Related U.S. Application Data
(60) Provisional application No. 62/835,889, filed on Apr. 18, 2019.

(30) Foreign Application Priority Data
May 2, 2019 (GB) 1906147.2
Sep. 9, 2019 (GB) 1912920.4

(51) Int. Cl. H01M 10/659; H01M 50/229; H01M 50/383; H01M 50/30; C04B 26/18

(52) U.S. Cl. CPC H01M 10/659; H01M 50/229; C04B 2111/00267; H01M 50/394; C04B 26/18; H01M 50/383

(57) ABSTRACT

The present disclosure relates to a shaped article for an energy storage device comprising greater than 60.0 wt % of an inorganic endothermic material and having an open porosity of greater than 10% v/v and less than 60% v/v, wherein the inorganic endothermic material comprises particles of inorganic endothermic material coated with a binder.

### FIELD OF THE INVENTION

The present invention relates to articles produced from endothermic material and processes for manufacturing thereof. In particular, the invention relates to endothermic energy storage device housing and associated components, including housing for a plurality of lithium ion batteries.

### BACKGROUND

Electrical energy storage devices may fail in operation, and this can result in an uncontrolled release of stored energy that can create localized areas of very high temperatures. For example, various types of cells have been shown to produce temperatures in the region of 600-900° C. in so-called “thermal runaway” conditions [Andrey W. Golubkov et al, Thermal-runaway experiments on consumer Li-ion batteries with metal-oxide and olivin-type cathodes RSC Adv., 2014, 4, 3633-3642].

Such high temperatures may ignite adjacent combustibles thereby creating a fire hazard. Elevated temperature may also cause some materials to begin to decompose and generate gas. Gases generated during such events can be toxic and/or flammable, further increasing the hazards associated with thermal runaway events.

Lithium ion cells may use organic electrolytes that have high volatility and flammability. Such electrolytes tend to start breaking down at temperatures starting in the region 130° C. to 200° C. and in any event have a significant vapour pressure even before breakdown starts. Once breakdown commences the gas mixtures produced (typically a mixture of CO₂, CH₄, C₂H₄, C₂H₅F and others) can ignite. The generation of such gases on breakdown of the electrolyte leads to an increase in pressure and the gases are generally vented to atmosphere; however this venting process is hazardous as the dilution of the gases with air can lead to formation of an explosive fuel-air mixture that if ignited can flame back into the cell in question igniting the whole arrangement.

It has been proposed to incorporate flame retardant additives into the electrolyte, or to use inherently non-flammable electrolyte, but this can compromise the efficiency of the lithium ion cell [E. Peter Roth et al, How Electrolytes Influence Battery Safety, The Electrochemical Society Interface, Summer 2012, 45-49].

It should be noted that in addition to flammable gases, breakdown may also release toxic gases.

The issue of thermal runaway becomes compounded in devices comprising a plurality of cells, since adjacent cells may absorb enough energy from the event to rise above their designed operating temperatures and so be triggered to enter into thermal runaway. This can result in a chain reaction in which storage devices enter into a cascading series of thermal runaways, as one cell ignites adjacent cells.

To prevent such cascading thermal runaway events from occurring, storage devices are typically designed to either keep the energy stored sufficiently low, or employ enough insulation between cells to insulate them from thermal events that may occur in adjacent cells, or a combination thereof. The former severely limits the amount of energy that could potentially be stored in such a device. The latter limits how close cells can be placed and thereby limits the effective energy density.

There are currently a number of different methodologies employed by designers to maximize energy density while guarding against cascading thermal runaway.

One method is to employ a cooling mechanism by which energy released during thermal events is actively removed from the affected area and released at another location, typically outside the storage device. This approach is considered an active protection system because its success relies on the function of another system to be effective. Such a system is not fail safe since it needs intervention by another system. Cooling systems also add weight to the total energy storage system thereby reducing the effectiveness of the storage devices for those applications where they are being used to provide motion (e.g. electric vehicles). The space the cooling system displaces within the storage device may also reduce the potential energy density that could be achieved.

A second approach employed to prevent cascading thermal runaway is to incorporate a sufficient amount of insulation between cells or clusters of cells that the rate of thermal heat transfer during a thermal event is sufficiently low enough to allow the heat to be diffused through the entire thermal mass of the cell typically by conduction. This approach is considered a passive method and is generally thought to be more desired from a safety vantage. In this approach the ability of the insulating material to contain the heat, combined with the mass of insulation required dictate the upper limits of the energy density that can be achieved.

A third approach is through the use of phase change materials. These materials undergo an endothermic phase change upon reaching a certain elevated temperature. The endothermic phase change absorbs a portion of the heat being generated and thereby cools the localized region. This approach is also passive in nature and does not rely on outside mechanical systems to function. Typically, for electrical storage devices these phase change materials rely on hydrocarbon materials such as waxes and fatty acids for example. These systems are effective at cooling, but are themselves combustible and therefore are not beneficial in preventing thermal runaway once ignition within the storage device does occur.

A fourth method for preventing cascading thermal runaway is through the incorporation of intumescent materials. These materials expand above a specified temperature producing a char that is designed to be lightweight and provide thermal insulation when needed. These materials can be effective in providing insulating benefits, but the expansion of the material must be accounted for in the design of the storage device.

WO2015179597 addresses the above limitations by providing a material possessing both insulative and endothermic properties, such that thermal runaway events may be isolated to within the battery pack through the material insulating unaffected cells from the thermal runaway event whilst the endothermic material functions to both absorb and carry away heat from the affected cell.

US2018/0205048 discloses a battery holder for a plurality of cells containing a thermoset resin matrix filled with an endothermic filler material. Upon exposure to a thermal runaway event, the resin is carbonised, whilst the filler material generates gas through the decomposition of the filler. The amount of endothermic material is limited to the amount able to be added to the thermosetting resin whilst maintaining the viscosity below 10 Pa·s or less to enable the battery holder to be moulded. Due to the carbonisation of the resin and release of energy, the net energy absorption capacity of the battery holder can be further improved.

WO2017/060705 discloses a thermal insulator to protect an article against fire, comprising a hydraulically set inorganic material comprising hydrated hydratable alumina which is hydraulically bonded together during the hydration process. The material can be shaped through casting or pressing and the resultant material machined and tooled. Whilst the energy absorption capacity was good, the processability of the composition constrained its suitability for end use applications involving complex or thin walled shapes.

WO 00/26320 discloses the use of a bicarbonate compound and an optional binder to form an endothermic composition which may be compression moulded into blocks or other shapes and located next to heat sensitive items. The ability to use low or no binder may be associated with the formation of aggregates or unbound particles being contained within the housing. Alternatively, the particles may be agglomerated through “curing” of bicarbonate compounds (e.g sodium bicarbonate) due to the absorption of moisture from the atmosphere in the outer layer. However, resultant articles are not mechanically robust nor hydrophobic and unsuitable for complex or thin walled shapes.

US2018/0006348 (U.S. Pat. No. 10,439,260B2) discloses the use of a combination of inorganic hydrates; organic endothermic material, such as sugar alcohols and hydrocarbons; and a binder with relatively high melting points (e.g. PVdF) to form an endothermic layer around a battery. Preferably no less than 50 mass % organic endothermic material is used to enable the density of the endothermic material to surpass 90% and the resultant housing to pass a nailing test.

US2011/0064983 discloses a heat insulating layer for use in a portable electronic device. The heat insulating layer comprising an endothermic material, such as inorganic hydrates. The endothermic material preferably has a particle size of between 500 μm and 3000 μm which is bound together with at least 5 wt % binder to prevent flaking or cracking. The composition may be mixed in a solvent and applied as a coating directly to the surface of the battery housing. In other embodiments the endothermic material is separated from the battery through ribs to create air spaces to inhibit thermal conduction.

Despite the benefits of these solutions, there is increasing demand for more compact and simplified housing articles which have both heat absorbing and heat insulative properties, and articles and compositions for use therein, which are able to control thermal runaway events.

There is therefore an unfulfilled need for a method to limit cascading thermal runaway in energy storage devices that mitigates the problems of previous proposals.

### SUMMARY OF THE INVENTION

In a first aspect of the present disclosure, there is provided an article for an energy storage device comprising greater than 60.0 wt % of an inorganic endothermic material (relative to the total weight of the article) and having an open porosity of greater than 0 and less than 60% v/v, wherein the inorganic endothermic material comprises particles of inorganic endothermic material coated with a carbonaceous binder, such that the article preferably has a moisture weight gain of less than 5 wt % when tested in accordance to ISO 1716 standards.

In a second aspect of the present disclosure, there is provided an article for an energy storage device comprising greater than 60.0 wt % of an inorganic endothermic material (relative to the total weight of the article) and having an open porosity of greater than 0 and less than 60% v/v, wherein the inorganic endothermic material comprises particles of inorganic endothermic material coated with a binder, said binder preferably comprises or consists of a decomposed thermoplastic binder preferably with an atomic ratio of oxygen to carbon of at least 1:15 (i.e. one or more atoms of oxygen to 15 atoms of carbon).

In a third aspect of the present disclosure, there is provided an article for an energy storage device comprising greater than 60.0 wt % of an inorganic endothermic material (relative to the total weight of the article) and having an open porosity of greater than 0 and less than 60% v/v, wherein the inorganic endothermic material comprises particles of inorganic endothermic material coated with a carbonaceous binder, wherein the article preferably does not deform greater than 5% or greater than 10% of its original dimension when subjected to a pressure of 74.4 kPa at a temperature 5° C. below the decomposition temperature of the inorganic endothermic material.

In a fourth aspect of the present disclosure, there is provided an article for an energy storage device comprising greater than 60.0 wt % of an inorganic endothermic material (relative to the total weight of the article) and having an open porosity of greater than 0 and less than 60% v/v, wherein the inorganic endothermic material comprises particles of inorganic endothermic material coated with a carbonaceous binder, wherein the article has a modulus of rupture (measured in accordance to ASTM C203 Method I) of at least 400 psi (2.76 Mpa). In one embodiment, the article is a freestanding article. In one embodiment the article is shaped. In another embodiment, the article is a moulded article, preferably an injection moulded article.

In yet a fifth aspect of the present disclosure, there is provided an article for an energy storage device comprising greater than 60.0 wt % of an inorganic endothermic material (relative to the total weight of the article) and having an open porosity of greater than 0 and less than 60% v/v, wherein the inorganic endothermic material comprises particles of inorganic endothermic material coated with a carbonaceous binder.

The disclosed articles combine:

(i) a high proportion of endothermic material to absorb energy;

(ii) open porosity to enable the gas and associated heat to be readily removed from the article following a thermal runaway event and to insulate the heat source from adjacent areas, particularly under normal operating conditions; and

(iii) a carbonaceous binder which coats the endothermic particles to both securely bind the particles together and protect the endothermic particles from absorbing moisture.

The present disclosure is able to provide improved endothermic performance compared to endothermic articles of similar mechanical performance, which rely on a substantial proportion of fillers, such as inorganic fibre, to impart the required mechanical properties. Endothermic articles which provide comparable endothermic material either require an additional housing enclosure to provide the mechanical support or are used in applications where the mechanical, insulative and/or heat dissipative properties of the article are not required.

The article possesses a high proportion of inorganic endothermic material (rather than organic endothermic material) to ensure the article has sufficient mechanical strength as well as energy absorptive capacity. The article is preferably monolithic. The article is preferably a moulded, cast, extruded or pressed article and even more preferably a moulded, extruded, cast or pressed article free of additional machining operations to further shape the article.

The carbonaceous binder may comprises decomposed organic matter, such as thermoplastic binder and/or surfactant. Decomposition of the organic matter may be through thermal decomposition or the like (e.g. radiation). The thermoplastic binder and/or surfactant used in the original formulation, is required to have low viscosity characteristics (e.g. less than 10 Pa·s or less than 5.0 Pa·s at the processing temperature) during manufacturing operations, such as injection moulding. The decomposition of the thermoplastic binder and/or surfactant typically results in the appearance of the article changing from a white to beige/brown colour due to the formation of decomposition products. Advantageously, the decomposition of the thermoplastic binder and/or surfactant results in the article possessing good mechanical strength above the melting point of the thermoplastic binder and/or surfactant prior to decomposition. Unexpectedly, the thermoplastic binder and/or surfactant can contribute to both the formation of complex article shapes through low viscosity and good surface contact, and then once transformed to a carbonaceous binder, are able to produce an article with good mechanical properties at elevated temperatures preferably up to and above the decomposition temperature of the endothermic particles. In the alternative, the carbonaceous binder may be an additive other than the surfactant, or a decomposition product of the surfactant. In general the carbonaceous binder may comprise products resulting from the decomposition or crosslinking of the thermoplastic binder, the optional additives, or both. However the carbonaceous binder may in the alternative, or also, comprise materials that do not result from the decomposition or crosslinking of the thermoplastic binder, the optional additives, or both.

The shaped article preferably comprises a low level of silicone (i.e. preferably less than 2 wt %, more preferably less than 1 wt %) and most preferably comprises no detectable levels of silicone. This enables the article to meet end of life recycling requirements.

In one embodiment, the article does not deform greater than 5% or greater than 10% of the article's original dimension (i.e. before pressure applied) when subjected to a pressure of 74.4 kPa at a temperature 5° C. below the decomposition temperature of the inorganic endothermic material. In another embodiment, the article does not deform greater than 5% or greater than 10% of the article's original dimension when subjected to a pressure of 74.4 kPa over a temperature range of room temperature to 250° C. or 300° C. or 400° C. or 500° C.

The decomposition of the thermoplastic binder and/or surfactant may result in gel formation, cross-linking and/or bonding with the surface of the endothermic material particles, thereby making the carbonaceous binder more mechanically resilient at higher temperatures. Preferably, the carbonaceous binder has a melting point higher than 100° C. or higher than 120° C. or higher than 140° C. or higher than 160° C. or higher than 180° C. or higher than 200° C. or higher than 220° C. or higher than 240° C. In one embodiment, the melting point of the carbonaceous binder is higher than the endothermic decomposition onset temperature of the inorganic endothermic material. In another embodiment, the carbonaceous binder does not have a melting point.

It will be understood that the term “decomposed thermoplastic binder” may encompass binders which may no longer be thermoplastic, with the decomposition process forming crosslinked organic compounds or gels which may not possess a melting point. The decomposed thermoplastic binder and/or surfactant may comprise carbon-oxygen bonds (e.g. carbonyl groups), such as organic acids and/or peroxides, particularly if decomposition occurred in an oxidative environment.

In one embodiment, the carbonaceous binder comprises an atomic ratio of oxygen to carbon of at least 1:15 or at least 1:12 or at least 1:10 or at least 1:8 or at least 1:4 or at least 1:3 or at least 1:2 (determined by XPS).

In another embodiment, the carbonaceous binder comprises a carbon content in the form of O═C—O species of at least 1.0 atomic % or at least 2.0 atomic % or at least 3.0 atomic % or at least 5.0 atomic % (determined by XPS).

In another embodiment, the carbonaceous binder comprises at least 1.0 atomic % or at least 2.0 atomic % or at least 3.0 atomic % or at least 5.0 atomic % (determined by XPS) of carbonyl groups (C═O).

The article may be used in any situation where energy is required to be absorbed, particularly where there are volumetric design constraints. Applications where the present disclosure provides particular advantages include automotive, rail, marine and aerospace industries, such as fire retardant applications; prevention of thermal runaway cascading in energy storage devices; and the protection of heat sensitive equipment, including flight data recorder equipment.

The article is preferably a housing for an energy storage device. The housing is preferably shaped to receive a variety of shaped and sized cells. In one embodiment the housing comprises a plurality of cylindrical recesses to house cylindrical batteries (e.g. 18650, 21700, 26650 type cells). Typical cylindrical dimensions range from between 8.5 mm to 75 mm in diameter to 18 mm to 70 mm in length.

Alternatively, the article may be used as dividers or separators in the form of plates or sheets located within the energy storage device (e.g. between cells or cell components; or between cells and other temperature sensitive components). The use of sheets or plates may be particularly suited for providing thermal runaway protection for prismatic cells. The good rigidity and high MOR strength of the sheets/plates are able to prevent swelling in the cells during operation.

The carbonaceous binder (or organic component) content may be between 0.5 wt % and 40 wt % or between 1.0 wt % and 30 wt % or between 0.5 wt % and 20.0 wt % or between 1.0 wt % to 18.0 wt % or between 1.5 wt % to 16.0 wt % or between 2.0 wt % and 15.0 wt %. Higher binder contents reduce the inorganic endothermic material density of the housing and may increase shrinkage and cracking. Lower binder levels may detrimentally affect the mechanical properties of the article. Furthermore, too low a binder content may detrimentally affect the flow characteristics of the endothermic material/binder mixture during manufacturing, which may limit the complexity of shapes able to be formed.

In one embodiment, the article preferably comprises greater than 65 wt % or greater than 70 wt % or greater than 80 wt % or greater than 90 wt % or greater than 94 wt % or greater than 95 wt % or greater than 96 wt % or greater than 97 wt % or greater than 98 wt % inorganic endothermic material.

The inorganic endothermic material preferably generates gas upon decomposition or reaction.

In one embodiment, the article comprises at least 95 wt % inorganic endothermic material and the inorganic endothermic material density is greater than 60% and less than 90% (or less than 80%) of the theoretical maximum density of the endothermic material. This embodiment provides an article with both high endothermic material content and sufficient open porosity to efficiently remove the endothermic material decomposition or reaction gases (and associated heat) from the heat source.

The inorganic endothermic material density relates to the density of the material used to form the article and does not take into account design features such as closed cavities.

Alternatively, an article with organic endothermic material may form part of an article/housing comprising a combination of organic and inorganic endothermic material, with the organic endothermic material functioning not only to bind the inorganic endothermic material particles together, but to also function as a phase change material absorbing energy during melting and/or vaporisation. In these embodiments, the housing/article is preferably enclosed to enable at least part of the organic endothermic material to change phase whilst still being contained within the housing. Escape of the organic endothermic material may result in contamination of other parts of the battery housing as well as potentially creating a fire risk. These embodiments are preferably combined with a pressure release vent to enable the escape of gases upon the inorganic endothermic material starting to decompose or react.

In some embodiments, the carbonaceous binder of the housing is less than 10.0 wt % or less than 8.0 wt % or less than 7.0 wt % or less than 6.0 wt % or less than 5.0 wt % or less than 4.0 wt % or less than 3.0 wt % or less than 2.5 wt % or less than 2.0 wt % of less than 1.5 wt %. The housing is more likely to be non-flammable and/or non-combustible the lower the carbonaceous binder content is. Removal of a portion of the carbonaceous binder in a shaped article may be required to achieve the desired level of carbonaceous binder. The amount of the carbonaceous binder is preferably sufficient to bind the particles together to the required level required in the application, and may be at least 0.3 wt % or at least 0.5 wt % or at least 1.0 wt % or at least 2.0 wt % to provide sufficient carbonaceous binder to maintain the mechanical integrity of the housing. Sufficient carbonaceous binder also coats the endothermic material's surface, thereby contributing to the housing being hydrophobic, a desirable feature of energy storage devices. Preferably, the housing has a moisture weight gain of less than 10 wt %, or less than 8 wt % or less than 6 wt %, or less than 5 wt % or less than 2 wt % or less than 1.5 wt % when tested in accordance to ISO 1716 standards.

Given the relatively small particle size distribution (e.g. D50<100 μm) and consequently high surface area (compared to larger particle sizes) and low binder content (e.g. <5 wt %), it is surprising that the article has such a good combination of mechanical and hydrophobic properties. The average thickness of the carbonaceous binder bonding the particles of inorganic endothermic material together may be less than 400 μm or less than 300 μm or less than 200 μm or less than 100 μm or less than 80 μm or less than 60 μm or less than 40 μm or less than 20 μm. This may be determined by calculating the surface area of the inorganic endothermic particles and the volume of carbonaceous binder. For example, with inorganic endothermic particles having a surface area of 1 m²/g and with a residual carbonaceous binder (density=0.9 g/cm³) content of 2 parts by weight carbonaceous binder to 100 parts by weight inorganic endothermic material, there is an average coating thickness of 22 μm.

An alternative means of expressing the uniqueness of the present disclosure, is that in some embodiments an article comprises a binder loading of no more than 1 g per 10 m² or 20 m² or 30 m² or 40 m² or 50 m² or 60 m² or 70 m² or 80 m² or 90 m² or 100 m² of surface area of endothermic material particles.

The endothermic capacity of the article/housing on an energy absorbed per unit volume basis is dependent upon the specified endothermic material's decomposition reaction and its density. Non-endothermic components of the housing detract from maximising the housing's endothermic capacity and, as such, their inclusion should provide a functional benefit. The non-endothermic materials of the present disclosure preferably contribute towards providing a housing with sufficient mechanical integrity, whilst enabling the endothermic material to be injection moulded, or otherwise processed, into the required shape.

In some embodiments, the article/housing is preferably non-combustible and/or non-flammable.

Preferably, the endothermic capacity of the article/housing on a mass basis is at least 800 J/g or at least 900 J/g or at least 1000 J/g or at least 1100 J/g or at least 1200 J/g as measured by DSC between room temperature and 1000° C. with a temperature increase of 20° C. per minute.

Preferably, the endothermic capacity of the article/housing on a volumetric basis is at least 600 J/cm³ or at least 800 J/cm³ or at least 1000 J/cm³ or at least 1200 J/cm³ or at least 1400 J/cm³ or at least 1600 J/cm³ or at least 1800 J/cm³ or at least 1900 J/cm³ as measured by DSC between room temperature and 1000° C. with a temperature increase of 20° C. per minute.

In some embodiments, the article/housing is made almost wholly of endothermic material, which advantageously provides a high energy absorptive capacity, whilst maintaining mechanical integrity under normal operating conditions. Unexpectedly, the use of thermoplastic binders, such as paraffin wax, (preferably combined with surfactants, such as fatty acids) are able to bind the endothermic particulate material together with sufficient mechanical integrity for use as an energy storage device housing.

Preferably the modulus of rupture of the article/housing (measured in accordance to ASTM C203 Method I) is at least 400 psi (2.76 MPa) or at least 500 psi (3.45 MPa) or at least 600 psi (4.17 MPa) or at least 700 psi (4.83 MPa) or at least 800 psi (5.52 MPa) or at least 900 psi (6.21 MPa) or at least 1000 psi (6.89 MPa) or at least 1100 psi (7.58 MPa).

In some embodiments, the housing has an open porosity in the range of 3% to 60% v/v or in the range 5% to 50% v/v or in the range of 10% to 40% v/v or in the range of 15% to 35% v/v or in the range of 20% to 32% v/v. In some embodiments, the open porosity is at least 12% v/v or at least 14% v/v or at least 16% v/v or at least 18% v/v. The magnitude of open porosity should correlate with the proportion of thermoplastic binder and additives removed post moulding. Differences in densities between the binders and the endothermic materials may result in varying degrees of open porosity. Although, as guidance, for an article in which at least part of the binder has been removed, the numerical value of the open porosity (% v/v) of the article is typically greater than the % wt amount of thermoplastic binder added, as the density of the inorganic endothermic material may be 2 to 3 times higher than that of the binder. In some embodiments, the open porosity is less than 60% v/v or less than 40% v/v or less than 35% v/v, with a lower open porosity tending to produce a more mechanical robust article.

A combination of suitable endothermic material and open porosity enables the thermal insulative properties of the article to be tailored to the required level. In one embodiment, the thermal conductivity (measured at 40° C.) of the article is no more than 5.0 W/m·K or no more than 4.0 W/m·K or no more than 3.0 W/m·K or no more than 2.0 W/m·K or no more than 1.0 W/m·K.

The open porosity enables gas from gas generating endothermic material to readily escape (without causing excessive cracking), thereby enabling gases and heat to also escape from the housing to thereby further mitigate the risk of thermal runaway cascading. The generation of gases (e.g. H₂O and/or CO₂) also has the ability to deprive the atmosphere of oxygen, particularly in enclosed environments. A higher open porosity can also add to the insulative properties of the housing, preventing cells of batteries adjacent to a thermal runaway event from overheating. Additionally, the open porosity may also contribute to improved stiffness of the article.

In a sixth aspect of the present disclosure, there is provided a process for the production of a shaped article comprising the steps of:

a. mixing together a formulation comprising:
i. particles of an inorganic endothermic material;
ii. a fugitive thermoplastic binder with a melting point below the endothermic decomposition temperature of the inorganic endothermic material; and optionally
iii. one or more additives.

b. heating the mixture above the melting point of the thermoplastic binder and below the decomposition temperature of the inorganic endothermic material;

c. shaping the mixture into a shaped article; and

d. removing at least part of the thermoplastic binder from the shaped article to leave a carbonaceous binder coating the particles of inorganic endothermic material.

In a seventh aspect of the present disclosure, there is provided a process for the production of a shaped article comprising the steps of:

a. mixing together a formulation comprising:
i. particles of an inorganic endothermic material;
ii. a thermoplastic binder with a melting point below the endothermic decomposition temperature of the inorganic endothermic material; and optionally
iii. one or more additive(s).

b. heating the mixture above the melting point of the thermoplastic binder and below the decomposition temperature of the inorganic endothermic material;

c. shaping the mixture into a shaped article; and

d. providing conditions which result in the decomposition or crosslinking of the thermoplastic binder and optional additives to form a carbonaceous binder.

Preferably, the process further comprises the step of removing part of the thermoplastic binder from the shaped article. Although, in some embodiments, the binder may not be removed.

The shaped article may be optionally cooled after shaping (step c) and prior to the optional removal of part of the thermoplastic binder.

The processing conditions used may result in the decomposition or cross-linking of the thermoplastic binder and optional additives so that the carbonaceous binder comprises products resulting from the decomposition or crosslinking of the thermoplastic binder, the optional additives, or both. These processing conditions may include thermal and/or atmospheric (e.g. raising the temperature of the thermoplastic binder and optional additives in an oxidative atmosphere to promote decomposition or cross-linking). Alternatively, cross-linking additives (e.g. hardening agents) may be used to cross-link the thermoplastic binder upon expose to an activation source (e.g. change in pH, UV light or other radiation wavelength) or catalyst.

For example, in one embodiment, the thermoplastic binder is polyethylene and additives such as peroxide or a cross-linking agent (e.g. vinylsilane) and a catalyst may be used to convert the thermoplastic binder into a cross-linked (or cross-linked like) carbonaceous binder. In doing so, the mechanical properties of the article may be enhanced at higher temperatures.

The shaped article is preferably an article according to one of the previous aspects of the disclosure.

Any suitable shaping technique may be used including, but not limited to, extrusion, cast moulding and powder injection moulding. The article may also be shaped through forcing the mixture through a die or pressing the mixture into a mould. Powder injection moulding is preferred for complex and thin wall article designs.

In some embodiments, the thermoplastic binder and optionally one or more additives preferably comprise phase change materials. The phase change materials, which change phase below the onset of endothermic decomposition or reaction, may advantageously regulate the temperature in the proximity to the endothermic article.

The removal of part of the binder is preferably performed by heating the article to a temperature above the melting point of the binder and below the endothermic decomposition temperature of the article. In other embodiments, the binder is removed in the presence of an absorbent powder, to enable a portion of the binder to be drawn out. The carbonaceous binder is thought to be preferentially maintained at the interfaces between the particles and as a thin film on the particles' surfaces. The removed binder and other organic additives result in an open porous article which facilitates the venting of gases during the decomposition of the endothermic material.

Alternative methods of binder removal may also be applied, including by chemical extraction (e.g. dissolving a portion of the thermoplastic binder with a suitable solvent).

Preferably, the thermoplastic binder has a melting point at least 10° C. or at least 25° C. or at least 50° C. below the endothermic decomposition onset temperature of the inorganic endothermic material. Being able to raise the temperature of the binder above its melting points provides more processing flexibility in being able to decrease the viscosity of the thermoplastic binder during moulding or during the removal of the binder. Lower viscosity enables a thinner coating of binder to encompass the inorganic endothermic materials which facilitates the use of lower binder levels.

The thermoplastic binder preferably comprises a paraffin wax.

To maximise the endothermic absorbent capacity, the article/housing preferably contains less than 15 wt % or less than 10 wt % or less than 5 wt % or less than 2 wt % and preferably no deliberately added (i.e. only present as impurities) inert fillers (e.g. fibres, ceramic oxides and/or inorganic binders). The article preferably consists of endothermic material; thermoplastic binder and optionally other additives. The additives, if present, are preferably organic and more preferably an organic surfactant.

Additives may be added up to 5 wt % or 10 wt % or 15 wt % of the total weight of the article (e.g. housing).

A surfactant, such as fatty acids, is a preferred additive. The surfactant preferably comprises between 5 wt % and 30 wt %, and more preferably 10 wt % to 20 wt %, relative to the thermoplastic binder.

In one embodiment, the carbonaceous binder comprises a thermoplastic binder and a surfactant (e.g. fatty acid, such as stearic acid) and/or decomposed products thereof.

During the removal of the binder, the binder is preferably decomposed (particularly the carbonaceous binder remaining in the article). This may be achieved through thermal decomposition if the thermal decomposition of the binder commences at a temperature below the endothermic material decomposition onset temperature. Preferably, the removal of the binder occurs at or above the decomposition temperature of the thermoplastic binder.

Alternatively, the binder may be exposed to radiation to decompose the binder. The decomposition (or partial decomposition) of the binder is thought to promote cross-linking, gel formation or other mechanism to increase the reactivity of the binder and strengthen its bond strength, particularly at temperatures above the melting point of the binder prior to decomposition.

### Inorganic Endothermic Materials

The inorganic endothermic materials preferably contain metal hydroxyl, hydrous, carbonate, sulphate and/or phosphate components which decompose or react at a designated onset decomposition or reaction temperature with the reaction or decomposition resulting in the absorption of energy. Examples of endothermic materials include sodium bicarbonate, nesquehonite, gypsum, sodium nitrate, magnesium phosphate octahydrate, aluminium hydroxide (also known as aluminium trihydrate), hydromagnesite, dawsonite, magnesium hydroxide, magnesium carbonate subhydrate, boehmite, zinc borate, antimony trioxide, and calcium hydroxide. The decomposition or reaction products are preferably non-toxic, such as carbon dioxide and/or water.

The decomposition or reaction products preferably provide an insulative barrier. It will be understood that the mechanical properties of the housing may deteriorate during a thermal runaway event, such that a more porous insulative article remains. For example, aluminium hydroxide will decompose to a porous alumina article as indicated by the formula below:

2Al(OH)₃≤Al₂O₃+3H₂O

The mechanical deterioration of the battery housing is of secondary importance to the objective of preventing propagation of the thermal runaway event and protecting adjacent equipment, as the thermal event is likely to render the battery module inoperable. However, it is desirable that the article retains its integrity to enable the article to still function as an insulative barrier.

TABLE A

| | | Decomposition |
|---|---|---|
| | | onset temp. |
| Mineral | Chemical Formula | (° C.) |
| Nesquehonite | >MgCO₃•3H₂O | 70-100 |
| Gypsum | CaSO₄•2H₂O | 60-130 |
| Magnesium phosphate | Mg₃(PO₄)₂•8H₂O | 140-150 |
| octahydrate | | |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate | >MgO•CO_{2(0.96)}H₂O_{(0.3)} | 340-350 |
| subhydrate | | |
| Boehmite | AlO(OH) | 340-350 |
| Calcium hydroxide | Ca(OH)₂ | 430-450 |

To assist the housing to maintain its form, a separate component comprising inorganic fibres may be disposed or adhered to an outer surface of the housing (e.g. between the housing and outer protective cover). The inorganic fibres (or paper containing thereof) are preferably refractory in nature and are able to withstand temperatures in excess of 1000° C. (e.g. Superwool® 607, Superwool® HT or Kaowool 1600 paper). The fibre is preferably in the form of a paper or scrim. The insulative barrier preferably has a thermal conductivity of less than 0.20 W/m·K and more preferably less than 0.01 W/m·K tested in accordance to BS 1902 Part 6.

Endothermic materials may be chosen to enable a specific energy absorption temperature profile to be obtained (see Table A), with a mix of two of more endothermic materials able to absorb energy over an extended temperature range.

In some embodiments, the endothermic material comprises a gas generating component (e.g. CaCO₃) and a non-gas generating component (e.g. NaNO₃).

### Particle Size Distribution

To enable the housing (or other articles) to have a sufficiently high proportion of endothermic material whilst also being able to be formed (e.g. powder injection moulded) into desired shapes, the endothermic material preferably has a bimodal particle size distribution. Preferably the peaks of the bimodal distribution are between 30 and 200 microns apart and more preferably between 50 and 150 microns apart.

The corresponding surface area of the particles may be between 0.5 m²/g and 5.0 m²/g. In one embodiment, the surface area of the particles are at least 0.8 m²/g or at least 1.0 m²/g.

Difficulties have been observed in obtaining shaped article with inorganic endothermic material greater than 85 wt % of the total product (prior to dewaxing), when the mixture has been mono-modal.

The theoretically maximum density of endothermic material is the density of the shaped article if it was made of 100 wt % endothermic material with no voids (i.e. the density of the endothermic material). The article/housing preferably has an inorganic endothermic material density of greater than 50 wt % or greater than 60 wt % or greater than 70 wt % or greater than 85 wt % or greater than 90 wt % of the theoretical maximum density of the inorganic endothermic material. The article/housing may be no more than 90% or 80% or 75% of the theoretical maximum density of the inorganic endothermic material. The combined density of the endothermic material (inorganic and organic) is preferably 50 wt % or greater or 60 wt % or greater or 70 wt % or greater than 75 wt % or greater than 80 wt % or greater than 85 wt % or greater than 95 wt % of the theoretical maximum density of the (inorganic and organic) endothermic material.

In one embodiment, a bimodal particle distribution comprises a d50 of the particles preferably in the range of 5 to 200 μm or 7 to 100 μm or 10 to 45 μm; a d90 of the particles preferably in the range of 40 to 400 μm and preferably in the range of 100 to 200 μm; and a d10 of the particles preferably in the range of 1 to 50 μm and preferably 2 to 10 μm. This particle size distribution, when combined with the appropriate thermoplastic binder and additives, enables the formation of shaped articles with thin walls.

When wall thicknesses of less than 5.0 mm are required, the smaller particle size distributions are preferred (e.g. d50 in the range of 10 to 45 μm). Larger particle size distributions or mono-modal particle size distributions may be sufficient for the production of less complex geometric shapes or articles with a lower proportion of inorganic endothermic material (e.g. <85 wt %) and/or with a higher level of open porosity.

### Thermoplastic Binder

The thermoplastic binder may be a fugitive binder, which is at least partially removable through heat treatment below the onset decomposition or reaction temperature of the endothermic material.

In some embodiments, the thermoplastic binder is an endothermic phase change material, such as waxes. The thermoplastic binder preferably comprises wax including paraffin wax or macro-crystalline wax which is a thermoplastic material composed primarily of normal alkanes with a carbon number in the range of 18 to 45. In their solid form, paraffin waxes are semi-crystalline with low melting points (e.g. 40 to 60° C.) and heats of fusion in the order of 150 J/g. In the melt, paraffin wax has a low viscosity (e.g. 7 MPa·s at 60° C., 5 MPa·s at 75° C. and 3 MPa·s at 100° C.) and a surface tension of typically about 25 mJ/m².

Whilst chlorinated paraffin may be used to enhance the fire retardancy of the housing, less toxic alternatives (e.g. unsubstituted paraffin wax) are typically preferred.

In alternative embodiments, the thermoplastic binder may be a polymer, such as polyolefins (e.g. polyethylene, including low density polyethylene), polycaprolactone or any suitable polymer with sufficiently low melting temperature and viscosity to facilitate powder injection moulding (PIM) of the inorganic endothermic material.

Whilst conventional endothermic compositions are known to comprise inorganic endothermic material and polymers (i.e. organic endothermic material), the required polymer content is higher, with the additional polymer material being reinforced with inorganic fibres (see U.S. Pat. No. 9,399,707). Unexpectedly, a composition with a significantly lower level of thermoplastic binder is able to form a mechanically stable article.

The choice of endothermic material will impact upon the choice of thermoplastic binder with the higher the onset temperature of endothermic decomposition, the greater variety of thermoplastic binders that will be available with a melting temperature less than the decomposition onset temperature.

In some embodiments, the binder (or the inorganic endothermic material) may comprise a foaming agent, which during the moulding process aerates the article to thereby reduce the article's density. The closed porosity of the article may be between 2% and 50% v/v or between 5% and 30% v/v. In other embodiments, the mixture may comprise a fugitive compound which volatilises during processing to further increase the porosity of the article.

### Additives

A range of additives known in the art may be incorporated into the mixture including, but not limited to surfactant, shrinkage modifier, gloss modifier, fire retardant, smoke suppressant, impact modifier, cure modifier, viscosity or rheological modifier, wetting agent (surfactant), dispersing agent, cross-linking agent, catalyst, antioxidant, foaming agent, lubricant, release agent, gelling agent, tack modifier, flow agent, acid scavenger, defoamer, processing aid, filler, inorganic binder, or a combination thereof.

It will be appreciated that the article may be coated in all or in part to enhance the surface properties in respect to thermal and/or electrical conductivity; smoothness or abrasiveness; and handleability or any other required functional property. In some embodiments, the mixture comprises particulate or fibrous inorganic filler. The fillers may be used to enhance mechanical properties of the material and resultant housing. It has been found that small amounts (e.g. less than or equal to 5.0 wt % or less than or equal to 4.0 wt % or less or equal to 3.0 wt % or less than or equal to 2.0 wt %) may enhance mechanical properties whilst still maintaining a high endothermic material density. Fillers of greater than 0.1 wt % or greater or 0.5 wt % or greater may provide benefits in terms of mechanical properties.

To enable article designs with greater design options, the use of lubricants and/or surfactants are preferably added. The lubricants and/or surfactants coat the endothermic particles surfaces and enable a higher endothermic material content to be injection moulded (or other shaping technique) with sufficient mechanical integrity, whilst enabling thinner wall thicknesses to be achieved.

The thermoplastic binder composition preferably comprises stearic acid that, in addition to being an endothermic phase change material, also functions as a lubricating aid and surfactant in the powder injection moulding process. Stearic acid is a saturated fatty acid with an 18 carbon chain and a melting point of 69° C. Stearic acid is thought to coat the surfaces of the endothermic material particles and prevent direct particle to particle contact. Insufficient stearic acid to coat the particle surface was considered to result in particle agglomeration and an increase in suspension viscosity. A surfactant content (e.g. stearic acid or other fatty acids) of up to 8.0 wt % of total organic matter; or up to 5.0 wt % of the mixture provides an advantageous effect, although higher amounts may result in cracking during the thermal removal of the binder.

The surfactant is thought to facilitate the bonding of endothermic particles together, particularly during thermal decomposition which facilitates the reaction of reactive groups (e.g. carboxyl or carbonyl groups) with the surface of the endothermic particles as well as the thermoplastic binder. Thus, the resultant surface layer is both hydrophobic and able to securely maintain a bond between the endothermic particles at temperatures above the initial melting temperatures of the surfactant and the thermoplastic binder.

Without limitation, suitable organic additives that may be used alone or as a mixture include polyethylene glycol, capric acid, elaidic acid, lauric acid, pentadecanoic acid, tristearin, myristic acid, palmitic acid, stearic acid, acetamide, methyl fumarate, formic acid, caprylic acid, glycerin, D-lactic acid, methyl palmitate, camphenilone, caprylone, phenol, heptadecanone, 1-cyclohexylooctadecane, 4-heptadacanone, p-toluidine, cyanamide, methyl eicosanate, 3-heptadecanone, 2-heptadecanone, hydrocinnamic acid, cetyl alcohol, napthylamine, camphene, o-nitroaniline, 9-heptadecanone, thymol, methyl behenate, diphenyl amine, p-dichlorobenzene, oxolate, hypophosphoric, o-xylene dichloride, chloroacetic, nitro naphthalene, trimyristin, heptadecanoic acid, bees wax, glycolic acid, p-bromophenol, azobenzene, acrylic acid, dinitrotoluene, phenylacetic acid, thiosinamine, bromcamphor, durene, benzylamine, methyl bromobenzoate, alpha napthol, glutaric acid, p-xylene dichloride, catechol, quinone, acetanilide, succinic anhydride, benzoic acid, stibene, benzamide, or any combination thereof.

In one embodiment, the surfactant comprises a carbonyl group. The carbonyl group provides a reactive group which is able to react during the processing of the article to bond to the endothermic particles and/or thermoplastic binder.

### Battery Housing Design

The battery housing preferably comprises a plurality of recesses to receive a plurality of cells. The cells may be of any shape, including cylindrical, prismatic, button and pouch. The capacity of each cell will dictate the magnitude of a possible thermal runaway event and the amount of energy absorptive capacity of the housing material required to mitigate the risk of a thermal event occurring in one cell propagating to cause thermal events in neighbouring cells.

The battery housing design is preferably such that each cell is at least partially encompassed by an endothermic material, to both limit the severity of heat generation during a thermal runaway event as well as insulating neighbouring cells from the generated heat to prevent migration of the event to neighbouring cells.

The housing design is preferably shaped to receive the cells and, as such, may comprise a plurality of cavities conforming to the shape of the cells (e.g. cylindrical, prismatic, button or pouch).

In one embodiment, the battery housing comprises a plurality of recesses with each recess being less than 20 mm or less than 10 mm or less than 5 mm or less than 2.5 mm distance from an adjacent recess. The housing preferably comprises at least 2 or 3 recesses or at least 5 recesses or at least 7 recesses or at least 9 recesses.

In order to increase the energy density of the battery module, the cells should be tightly spaced together with the battery housing walls or partitions being minimised. The minimum wall thickness may be dictated by a number of design constraints including, but not limited to:

limitations of the shaping (e.g powder injection moulding) process;

the mechanical strength requirements of the housing;

the required energy absorption capacity of the housing; and

insulative properties of the wall.

The minimum wall thickness of within the battery housing is typically less than 20 mm or 10 mm for small capacity batteries (e.g. 10 Ah or less; or 5 Ah or less; or 2 Ah or less or 1 Ah or less) although the minimum wall thickness may proportionally increase with the battery capacity and housing design.

The formulations and shaping processes of the present disclosure enables minimum wall thickness to be as low, for example, as 0.50 mm, although other design constraints, such as the housing energy absorptive capacities typically requires the minimum wall thickness to be at least 0.8 mm or at least 1.0 mm.

In one embodiment, the minimum wall thickness is the range of 0.5 mm to 20 mm or 1.0 mm to 10 mm or 2.0 mm to 5.0 mm.

The unique combination of high endothermic material content, high mechanical strength and the ability to form complex shapes with thin walls provides a high degree of design flexibility. The function of the cavities may be to reduce the total weight of the article in combination with the ability to control the porosity of the article.

The cavities may be placed within the article, such that the energy absorption capacity of the article is not diminished. This may be achieved through providing an article which comprises an energy absorption density profile aligned to the energy release profile of the energy storage device (i.e. higher energy absorption density where higher energy release energy is located). The inclusion of one or more spacing cavities also has the effect of further improving the insulative properties of the article between the energy storage device and the external wall(s) of the article.

The size and shape of the cavities may be dictated by the energy absorption requirements of the energy storage device as well as the mechanical properties of the material used. In one embodiment, the shaped article may comprise one of more cavities. The cavities are preferably defined by wall(s) having a minimum wall thickness in the 0.5 mm to 20 mm range. In one embodiment, the cavities are open cavities, which enable efficient de-waxing of the shaped article during processing. In other embodiments, the cavities are closed or sealed cavities. Sealed cavities may be used to store a phase change material within the article to better regulate the energy storage device temperature to optimise battery storage. In other embodiments, the cavities are designed to house battery sensors and/or other components of the battery management system.

In other embodiments, the cavities comprise storage fluids which are sensitive to temperature and/or pressure within the cavity; and housing sensors (preferably remote sensors) which monitor the condition (e.g. temperature and/or pressure) of the fluid. The sensors are able to monitor the conditions of the energy storage device and communicate with a battery management system to shut down an energy storage module prior to a likely thermal runaway event.

In order to distribute and equalize the heat of the cells during a normal operation of battery module, the battery housing/article may be made of a material of relatively high thermal conductivity. A suitable example is an endothermic material, such as metal hydroxide (for example, aluminium hydroxide). The conductivity of the endothermic material may be further enhanced through the addition of conductive components, such as graphite or carbon (including carbon nanotubes and graphene). Alternatively, the surface of the endothermic material adjacent the battery cells may be coated with a conductive coating such that in the event of a “hot spot” the temperature may be efficiently conducted throughout the energy storage device to activate a larger proportion of the endothermic material, thereby more effectively absorbing the emitted energy within a cell to prevent thermal runaway.

In another embodiment, the housing may comprise a separate containment lattice member comprising a plurality of openings to accept the cells. The lattice member material may comprise conductive materials such as graphite or metal which may be in open cell or a foamed configuration.

For the purposes of the present disclosure, embodiments referencing a housing (a specific embodiment of an article) will also be taken as referencing an article.

For the purposes of the present disclosure, the term “decomposed” means transformation from the original chemical structure, including the breakdown or reaction of the chemical structure during processing (e.g. thermal and/or oxidative and/or radiative degradation).

The term “organic component” refers to the combination of thermoplastic/carbonaceous binder and organic additives.

The term “cross-linked like carbonaceous binder” refers to a carbonaceous binder which, when used to bind an article, is able to not deform greater than 5% of the article's original dimension when subjected to a pressure of 74.4 kPa over a temperature range of room temperature to 220° C. or to 500° C. The cross-linked like carbonaceous binder may comprise decomposed thermoplastic binder. The cross-linked like carbonaceous binder may contain a portion of thermoplastic binder. The cross-linked like carbonaceous binder may comprise carbon chains which are cross-linked or form gels.

The term “open porosity” refers to the open void spaces of the material(s) making up the shaped article (i.e. inherent in a material's microstructure), but does not include machined, moulded or otherwise manufactured open void spaces forming part of the shaped article's design (e.g. cooling channels).

For the purposes of the present disclosure, the term “decomposed thermoplastic binder” or “decomposed residual binder” or “decomposed binder” means the decomposed product of the thermoplastic binder and organic additives, including surfactants.

### BRIEF DESCRIPTION OF THE DRAWINGS

FIG. 1 is a graph of the particle size distribution of Aluminium Trihydrate (ATH) in a preferred embodiment of the present disclosure.

FIG. 2 is a SEM image of an article comprising the endothermic material having the particle size distribution of FIG. 1, prior to dewaxing.

FIG. 3 is a SEM image of an article of FIG. 2 after dewaxing.

FIG. 4 is an Energy Dispersive X-ray spectroscopy (EDS) display of the SEM image of FIG. 3, with the light colour representing the presence of carbon.

FIG. 5 is a SEM image of another article after dewaxing.

FIG. 6 is an EDS display of the SEM image of FIG. 5, with the light colour representing the presence of carbon.

FIG. 7 is a perspective view of a battery housing design moulded using the ATH particles of FIG. 1.

FIG. 8 is a photograph of the test equipment used in determining the gas generation of the endothermic composition forming the housing.

FIG. 9 is a graph of the thermal mechanical analysis of a dewaxed endothermic article.

FIG. 10 is a graph of the thermal expansion of a sample upon heating and cooling of an endothermic article comprising the endothermic material.

FIG. 11 is a graph of the Thermal Gravimetric Analysis (TGA) and Differential Scanning calorimetry (DSC) of the endothermic material.

### DETAILED DESCRIPTION OF A PREFERRED EMBODIMENT

An approximately 25 Kg batch was prepared by measuring out 21.25 Kg of Aluminium Trihydrate (ATH); 3.00-3.19 Kg of paraffin wax (melting point: 52° C.); and the remaining 0.56-0.75 Kg of stearic acid. The material in its injected state is comprised of 82-87 wt % Aluminium Trihydrate (ATH) (containing a maximum of 0.3 wt % Na as Na₂O).

The remaining 13-18 wt % is comprised of organics which can be broken down further to 15-20 wt % stearic acid and 80-85 wt % paraffin wax. The stearic acid has two functions in the formulation, acting as a wetting agent for the mix and a lubricant for injection into the moulds. If the stearic acid drops below 1.5 total wt % then the material does not mix well and as a result there are issues filling a desired mould. The paraffin wax acts as a fugitive binder and, when the mix is heated above the melting point of the paraffin wax (e.g. about 52° C.), the mixture's viscosity is sufficiently reduced to fill the desired mould.

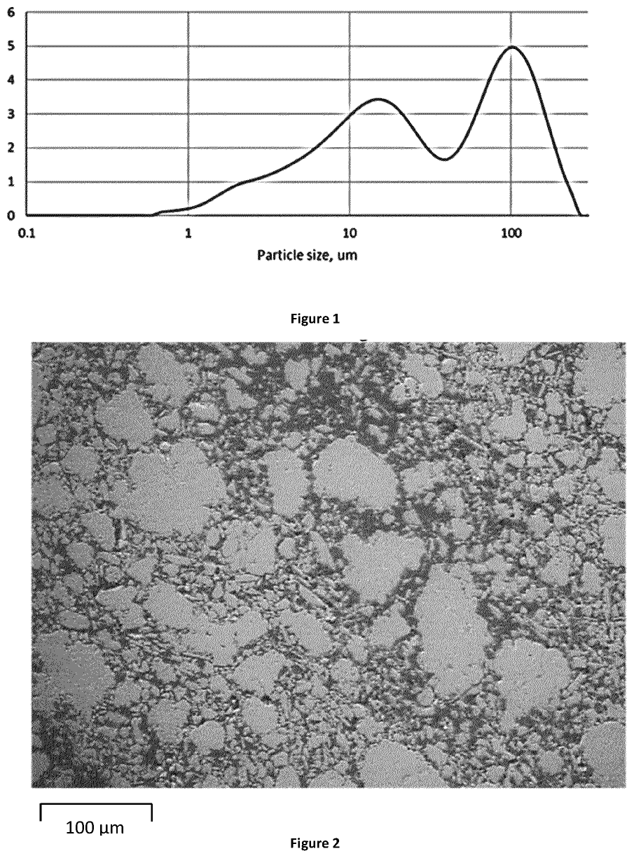

The ATH can be characterized further by particle size distribution with the final mixture having a d10 of 4.46 micron; a d50 of 30.7 micron; and a d90 of 148 micron. The particle size distribution is illustrated in FIG. 1. A bimodal particle size distribution was obtained through blending two separate batches of ATH, each having a different d50; one about 100 micron and the other just over 10 micron. The surface area of the ATH was 1.07 m²/g.

An exemplary bimodal distribution might have a first peak in the range 5-30 micron and a second peak in the range 50-300 micron. The present disclosure does not require such a distribution, and does not exclude distributions having only one, or having more than two peaks.

FIG. 2 further illustrates the bimodal distribution of particles within the wax based organic component (darker phase).

The materials are added to a heated mixer and mixed for about 6 to 10 hours at a heat setting to melt the wax and mixing time to obtain a homogeneous mixture. The mixture is transferred to an injection moulding press with a heated cavity. The cavity is heated to between 54-65° C. to maintain the desired low viscosity of the mixture.

The desired mould is placed on the machine and the mould cavity is sprayed with a silicon lubricant for ease of ejection. The mixture is injected to the desired mould at 2200-6650 kPa; the pressure is determined by the mould complexity and size and will require trials to optimize the settings for each specific mould. The cycle time per part will vary anywhere from 1-5 minutes depending on part size and geometry.

The mould is allowed to rest for a short period of time (e.g. 10 to 30 minutes) to allow for solidification of the wax. The resulting material is now in a solid state in the desired shape from the mould with the addition of the sprue from injecting. The sprue is removed and discarded, and the material is transferred to a setter with a powdery packing media used to draw out and absorb the organic components (wax and stearic acid).

Once the setter is filled with parts the parts are covered with the powdery packing media. The setters are then transferred to a tunnel kiln. The kiln is progressively heated from 110° C. to about 200° C. to wick out the wax (in air); this process typically takes 18-36 hours. It is thought that the extended period the organic material is exposed to high temperatures in an oxidative environment results in the residual organic material beginning to decompose and react and bond the ATH particles together. While the processing temperature does not reach the thermal decomposition of stearic acid, it does reach the decomposition of the wax. It is thought that reactive carbon-oxygen bonds, either created in the oxidative environment and/or the carbonyl groups in the surfactant, result in reaction products which bond the endothermic particles together.

The upper temperature limit is selected to avoid decomposition of the endothermic material. The parts are then removed from the packing media and any traces of the powdery media are removed by brush or air.

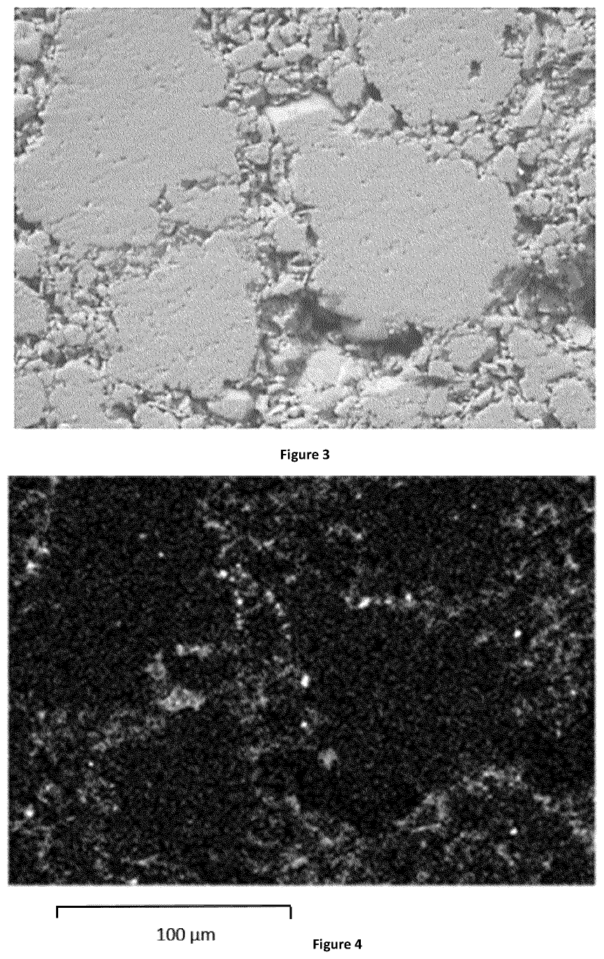

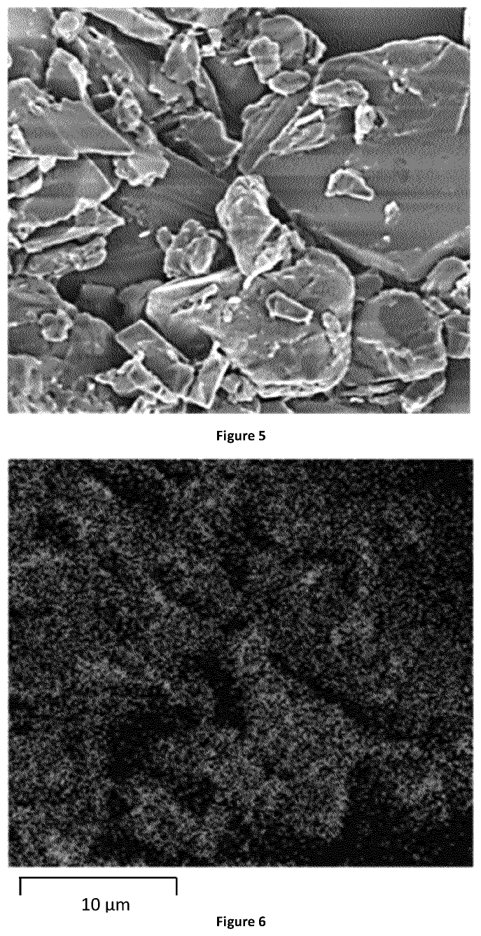

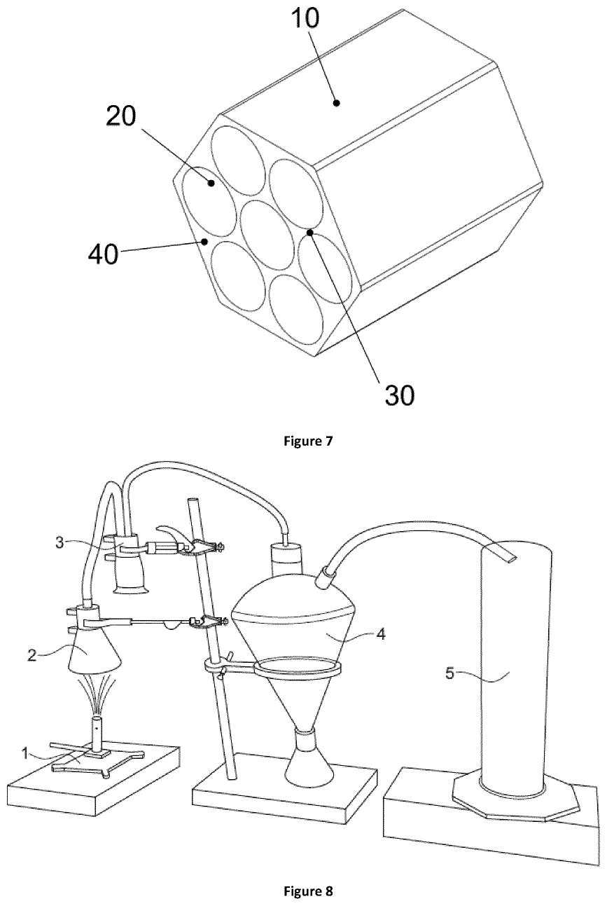

FIGS. 3 & 5 illustrates the material after the dewaxing process with void space occupying where the organic matter previously was. However, through EDS analysis (FIGS. 4 & 6), residual organic matter may be detected through the detection of carbon on the surfaces and congregating at the interfaces between particles, thereby functioning as a binder. The carbonaceous binder appears to concentrate around the smaller particles (i.e. areas with relatively high surface area), indicating that the bimodal particle size distribution may possess a synergistic benefit in terms of packing density, mechanical strength and adhesion between particles.

The resulting material (sample 7) is comprised of about 98 wt % ATH with the remaining weight percentage being the residual decomposed organic content (wax and stearic acid) and inorganic impurities including silica, calcia, magnesia, sodium oxide, iron oxide, and zirconia. The remaining organic content contributes to the overall MOR strength of the material while not affecting the flow of material during a thermal event and/or normal operating temperatures.

On the basis of there being 2 wt % residual carbonaceous binder, then 2 g of residual carbonaceous binder coated (98 g×1.07 m²/g) 104.9 m² of ATH particles (1 gram per 52.4 m² of ATH particles).

The residual organic content was determined by a mass balance of materials used and material removed in the dewaxing process.

After complete thermal decomposition the remaining material comprises>99 wt % alumina.

The process has some similarities with investment or lost-wax casting, with the distinction that the wax is not used to form wax patterns, but to act as a carrier and binder for the endothermic material. However, like investment casting it is able to produce components with high accuracy, repeatability and versatility.

As illustrated in FIG. 7, the moulded battery housing 10 is a hexagonal shape comprising seven cavities 20 each for receiving a 21700 size cylindrical cell. It will be appreciated that the weight of the housing could be further reduced by providing one or more open cavities to reduce the mass of material used.

The housing 10 had a hexagonal close packed design with seven cells. The cylindrical cavity diameter is between 21.2 mm and 21.6 mm, whilst the distance between adjacent central axes is 22.9 mm, resulting in a minimum wall thickness 30 of between 1.3 mm and 1.5 mm. The hexagonal shaped housing also has regions of greater wall thickness 40, adjacent the outer perimeter of the housing, thereby contributing to the structural stability of the housing.

For destructive battery testing the housings were wrapped with a 3.2 mm Superwool® Plus paper (for cushion) and placed inside an aluminium shell to simulate the protective cover article in operation (not shown).

In use, the battery housing holds seven 21700 size cylindrical batteries, with one end of each battery interfacing with a positive side current collector interfacing with battery connectors protruding from the cavities 20; and a negative side current collector interfacing with battery connectors protruding from the cavities 20 at the opposing ends (not shown). Other components, such as insulating plates, energy management system circuitry and sensors may also interface with the batteries and/or battery holders.

In some embodiments, the housing may contain cavities for the insertion of sensors into the housing to monitor the conditions, such as temperature. The use of PIM enables narrow conduits (e.g. less than 5.0 mm, preferably less than 2.5 mm and even more preferably less than 1.0 mm diameter) to be pre-formed into the housing, thereby avoiding the need to machine such design features in a separate operation.

### Experiments

Comparative example (CE1) is a test sample made from a composite material comprising inorganic fibre and ATH (approximately 62 wt %). In comparison a composition (sample 7; 98 wt % ATH) under the scope of the present disclosure is able to provide between 3.24 to 4.28 times more endothermic absorptive capacity per unit volume of material. This is due to an increase in density of endothermic material and an increase in concentration of endothermic material (i.e. lower content of non-endothermic material). Samples 1 to 6; and 8 to 13 referred to below were produced using the same methodology as with sample 7, except for the differences noted in Table 4 (particle size distribution); loading of organic material in Table 5; and fillers in Table 8.

### Relative Gas Generation

TABLE 1

| | | | Theoretical |
|---|---|---|---|
| | | | Total |
| | Gas | Collected | Gas/Generation |
| | Expansion | water Vapor | Expansion |
| | ml/g of | ml/g of | ml/g of |
| Sample | material | material | material |
| CE1 | 41.0 | 0.173 | 335.3 |
| 7 | 44.0 | 0.233 | 440.3 |

The gas expansion and gas generation data were obtained through the methodology as follows:

1. The condensation chamber is weighed and clamped in place, 10 grams of the desired test material is weighed out +/−0.05 grams and placed in the 250 ml beaker, and the plugs were put in place to seal the system.

2. The water chamber is filled to equilibrium for the pressure and temperature of the room.

3. The Bunsen burner is lit and set at a distance so that the tip of the inner blue flame is at the base of the beaker.

4. The test is allowed to run for 20 minutes before removing the Bunsen burner.

5. The collected water in the graduated cylinder is measured and reported.

6. The condensation chamber is weighed. Assuming pure water (density of 1 g/cc) the ml of water is recorded.

7. Using the Ideal Gas Law (PV=nRT) the theoretical expansion of the water from liquid to vapour is calculated and reported.

With reference to FIG. 8, (from left to right), there is illustrated a propane powered Bunsen burner (1) is placed below a 250 ml beaker (2) containing the test material. The beaker is hermetically connected to a condensation chamber (3) which in turn is hermetically connected to a water chamber (4). The water chamber deposits water into a graduated cylinder (5) for measurement.

### Relative Density, MOR, Hydrophobicity; Flammability and Combustibility

The residual coating of organic material (carbonaceous binder) on the surface of the article resulted in a very low level of moisture absorption. Additionally, despite the composition not containing fillers, the MOR of the article under the present disclosure is significantly higher than the comparative example comprising inorganic fibre.

TABLE 2

| | | | Hydrophobicity % |
|---|---|---|---|
| Sample | Density (Pcf) | MOR (psi) | wt gain (ISO 1716) |
| CE1 | 43 | 268 | 74% |
| 7 | 102 | 769 | 1% |

The density was determined by weighing a sample of known volume.

Modulus of Rupture (MOR) was determined according to ASTM C203 Method I.

The hydrophobicity was determined according to ISO 1716.

Sample E-1 did not propagate a flame according to UL 94, a V-0 rating recorded (i.e. no glowing after 30 seconds, no flame or combustion after being exposed to the flame).

The LOI test procedure (900° C. hold for 30 minutes) resulted in an LOI of 35%. This is mostly due to the conversion of the chemically bound water from the ATH.

E-1 also passed ASTM136 (Standard Test Method for Behaviour of Materials in a Vertical Tube Furnace at 750° C.) as non-combustible.

### Surface Analysis (XPS)

XPS experiments were performed using a Physical Electronics VersaProbe II instrument equipped with a monochromatic Al ka x-ray source (hv=1,486.7 eV) and a concentric hemispherical analyzer. Charge neutralization was performed using both low energy electrons (<5 eV) and argon ions. The binding energy axis was calibrated using sputter cleaned Cu (Cu 2p_{3/2}=932.62 eV, Cu 3p_{3/2}=75.1 eV) and Au foils (Au 4f_{7/2}=83.96 eV).

Peaks were charge referenced to CHₓ band in the carbon 1s spectra at 284.8 eV. Measurements were made at a takeoff angle of 45° with respect to the sample surface plane. This resulted in a typical sampling depth of 3-6 nm (95% of the signal originated from this depth or shallower). Quantification was done using instrumental relative sensitivity factors that account for the x-ray cross section and inelastic mean free path of the electrons.

Ground material was analysed of sample 7 before (green) and after the de-waxing step (final product). The results (Table 3) indicate that the surface of both samples was coated with a carbonaceous material. This was confirmed with EDS analysis which confirmed that a surface layer of carbon at least substantially, if not entirely, covered the surface of the ATH particles. While only a small amount of carbon in the green sample was present as carbonyl groups, likely to be derived from the stearic acid, the carbonaceous material in the final product had a higher atomic ratio of oxygen to carbon, indicating a likely higher concentration of stearic acid and the formation of thermal oxidative degradation products during the dewaxing process. Two possible spectra curve fits were used to calculate the proportion of functional groups, with the carbon/oxygen functional groups determined to be O═C—O, with the possibility of the presence of a C═O functional group.

On the basis that Al is present as Al₂O₃ and Na is present as Na₂O, then the remaining oxygen is 19.5 atomic %. This compares with 4.5 atomic % in the green sample, with 1 atomic % of this attributable to the O═C—O group. The final product has a ratio of oxygen to carbon of 19.5 to 41.8 (1:2.1). In contrast, the green product has a ratio of oxygen to carbon of 4.5 to 85.0 (1:18.9).

TABLE 3
(atomic %)

| | | | | | C as | C as | C as | CHₓ/ |
|---|---|---|---|---|---|---|---|---|
| Sample | Al | Na | O | C^{total} | CHₓ | O═C—O | C═O | COO |
| 7 (green) | 4.1 | 0.2 | 10.7 | 85.0 | 84.5 | 0.5 | — | 178 |
| 7 (final | 14.8 | 1.1 | 42.2 | 41.8 | 35.6 | 3.0 | 3.3 | 12 |
| product) | | | | | | | | |
| Fit 1 | | | | | | | | |
| 7 (final | 14.8 | 1.1 | 42.2 | 41.8 | 36.3 | 5.6 | — | 6 |
| product) | | | | | | | | |
| Fit 2 | | | | | | | | |

### Thermal Mechanical Analysis (TMA)

TMA (Thermal Mechanical Analysis) was performed on sample 7 (green) and sample 7 (final product). The test methodology is based on ASTM E228, but with the application of an applied load. A Netzsch TMA 402 F3 Hyperion machine was used. The sample size was ¼″×¼″×1. The sample was placed vertically into the test chamber and a force of 3N was applied to the ¼″×¼″ face (or 74.4 Mpa of pressure) of the sample. During the test, the samples were heated at a rate of 0.5° C./min and subjected to 74.4 kPa of pressure. The testing equipment measures material displacement as a function of temperature. The displacement or distortion was measured as a % of the original sample dimension in the direction of the applied force (i.e. 100% displacement corresponds to a 1″ displacement).

For sample 7 (green), the sample failed (e.g. deformed greater than 100% of its original length) at about 50° C., corresponding to the softening/melting temperature of the wax. This indicated that the mechanical strength of the sample was limited to the mechanical strength of the binder (wax) at elevated temperatures.

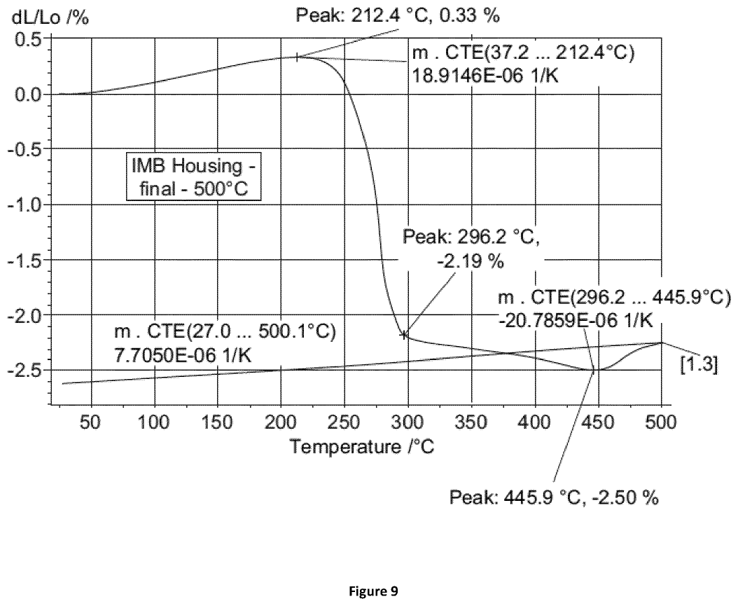

For sample 7 (final product), the material initially expanded before beginning to deform against the subjected force at about 212° C., corresponding to the temperature at which the ATH commences degradation. The sample deformed to a maximum of 2.5% of its original length up to a temperature of 500° C. (FIG. 9). This indicated that the residual binder was able to maintain the mechanical integrity of the sample up until at least the endothermic on-set temperature. This indicates that the residual organic material has an increased melting temperature or is no longer a thermoplastic material (e.g. a bonded to ATH, crossed-linked and/or gelled compound).

### Thermal Expansion

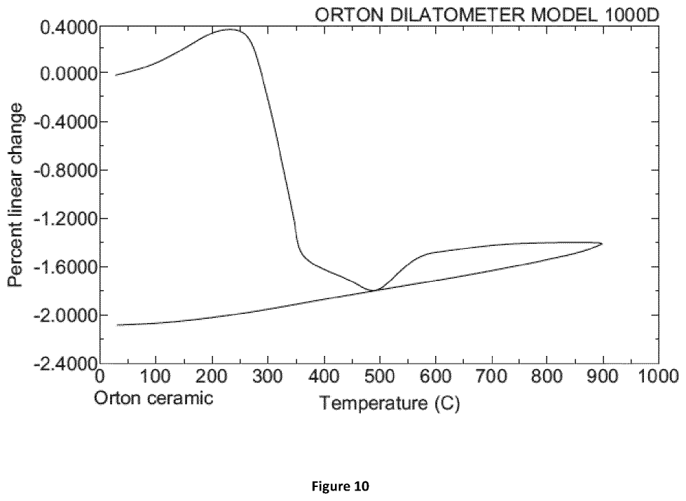

Thermal Expansion was determined in accordance to ASTM E228. As illustrated on FIG. 10, the linear expansion of a sample of the material increases to almost 0.4% at amount 250° C. before shrinking to −1.8% up to 500° C. corresponding to the release of ATH decomposition products (H₂O and CO₂). The shrinkage resulted a minor cracking although the sample maintained sufficient mechanical integrity to provide an insulative barrier after the endothermic material had decomposed.

### Thermal Gravimetric Analysis and Differential Scanning Calorimetry

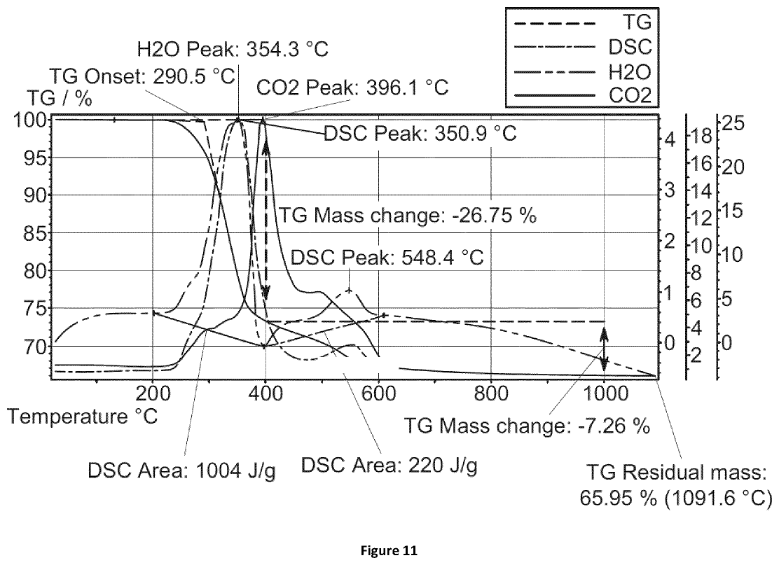

The Thermal Gravimetric Analysis (TGA) and Differential Scanning calorimetry (DSC) was measured using Simultaneous Thermal Analysis (STA). The data reported was provided by a third party (The National Brick Research Center, Clemson University) who collected the data in the following conditions: ambient temperature (20° C.) to 1000° C. at a ramp rate of 20° C. per minute in a standard air atmosphere with the sample contained within an alumina crucible. The results (FIG. 11) indicate an initial endothermic peak with an onset temperature between 200° C. and 250° C., absorbing greater than 800 J/cm³ as an individual peak combined with a secondary endothermic peak with the onset temperature between 400° C. and 450° C., absorbing greater than 100 J/cm³ as an individual peak yielding a total endothermic value greater than 800 J/cm³ (and >1000 J/g) for the entirety of the material.

TGA analysis of the sample prior to dewaxing revealed a peak at 227° C. which corresponded to a release of CO₂, indicating the combustion of organic material (e.g. wax). No such peak was observed on the dewaxed sample.

### Open Porosity

Open porosity was calculated using density measurements obtained by an autopycnometer, specifically a Micromeritics Autopycnometer (Model 1320 Serial #208), utilising helium gas. A sample of at least 3 cm³ is analysed, with a standard steel ball used as a reference check before each run.

The absolute density (also known as true, real, apparent or skeletal density) measures the volume of a sample excluding the pores and open void spaces between bound particles. (i.e. the pycnometer negates all open porosity). Therefore by taking the difference between the absolute density and bulk density of the same sample prior to the test, the open porosity can be determined.

The open porosity of sample 7 was determined to be approximately 30% v/v. As the density of ATH is approximately 2.4 g/cm³ and the density of binder is approximately 0.9 g/cm³, this equates to up to 87% of the added organic material being removed. This result is consistent with the calculated density of the sample 7 (1.63 kg/m³) which is about 68% of the maximum theoretical density of ATH, noting that the difference may be due to the presence of a small proportion of closed pores in the sample.

### Effect of Particle Size Distribution

It was found that having a bimodal particle size distribution (for example as exemplified in FIG. 1) provides the best injection quality (while maintaining organics loading) for the hexagonal housing (FIG. 7), the highest MOR strength, and an acceptable linear shrinkage. It will be appreciated that other shapes and designs may result in different optimised particle size distributions.

TABLE 4

| | | | | Injection | | MOR |
|---|---|---|---|---|---|---|
| Sample | d10 | d50 | d90 | quality | Shrinkage % | (psi) |
| 1 | 4.62 | 54.2 | 132 | Poor | — | 750 |
| 2 | 4.32 | 36.7 | 147 | Fair | 0.35% | 625 |
| 3 | 4.46 | 30.7 | 148 | Good | 0.60% | 820 |

The Particle Size Distribution was measured using a Malvern Mastersizer 3000. This tool utilizes laser diffraction measurement by which a laser beam passes through a dispersed particulate sample and the angular variation in intensity of the scattered light is measured.

### Effect of Organics Loading

An increase in organics (wax and stearic acid) resulted in a decline in mechanical strength as measured through the MOR and an increase in shrinkage.

TABLE 5

| Sample | Organics | Shrinkage % | MOR (psi) |
|---|---|---|---|
| 4 | 14.0 wt % | 0.42 | 895 |
| 5 | 15.0 wt % | 0.60 | 820 |
| 6 | 17.5 wt % | 0.93 | 640 |

Shrinkage was determined through measuring the difference in a known dimension in the green state after moulding and again after the de-waxing step performed at about 190° C. for 18 hours.

### Effect of Fillers

A variety of fillers (fibrous and particulate) were added in small amounts (e.g. <5 wt %) to the sample 7 formulation. The additional fillers were found to generally increase density and mechanical strength (MOR), although at the detriment of the insulation properties of the material, as indicated with higher Cold Face Temperatures being recorded.

TABLE 6

| | | | | Cold Face |
|---|---|---|---|---|
| | Additive | | | Temperature |
| Formula | package | Density (pcf) | MOR (psi) | (° C.) |
| 7 | A | 102 | 769 | 215 |
| | | [1.63 kg/m³] | | |
| 8-13 | B-G | 100-106 | 967-1118 | 236-276 |

Additive package:

A: 2.5-3% stearic acid

B-G: 2.5*3% stearic acid and 1 to 4 wt % filler

### Flame Screening (Cold Face Test)

This methodology tests the resistance to a lithium ion battery fire with direct flame impingement. The method includes using a Bernzomatic™ propane torch set 89 mm away from the test sample. The sample is subjected to the flame for 5 minutes while the cold face is monitored.

Samples were 8-inch (203 mm) discs clamped at the bottom 1 inch (or 25 mm) to secure the sample during testing. The optimal sample thickness was 0.25-0.28 inches (6.5 mm-7 mm). The flame was applied to the centre of the disc face or 4 inches (101 mm) from the edge of the sample perpendicular to the disc surface.

### Destructive Battery Housing Testing

Housing (FIG. 7) with a minimum wall thickness of 1.5 mm made from CE-1 and Sample 7, and fitted with Samsung 50E 21700 cells.

The “Control” example separated the batteries by an equivalent distance to the other examples with an air gap.

### Thermal Runaway Initiation Mechanism (TRIM)

The method consists of applying a high-powered heat pulse to a small area on the cell's external surface. A resistive heating element was provided in thermal contact with an outer edge of the battery cell. A section of the outer wall was removed to enable the heating element to provide the required thermal contact.

An energy source is provided to the resistive heating element and the target cell heated at 50° C./s until 500° C. or until thermal runaway obtained.

Further details on the procedure and resistive heating element used may be found in WO2018132911, which is incorporated herein by reference.

TABLE 7

| | Time to thermal | Max. temp, of |
|---|---|---|
| Material | runway (s) | adjacent cell (° C.) |
| Control (air gap) | 7.4 | 122.5 |
| CE-1 | 7.8 | 116.8 |
| Sample 7 | 67.7 | 88.5 |

The results highlight that the housing under the present invention significantly delays the onset of a thermal runaway event and once initiated the thermal event is less severe, as indicated by the lower maximum temperature of an adjacent cell within the housing.

### Nail Penetration Test

The nail penetration procedure that was followed was based on SAE J2464:

1. Start with fully charged cell (100% SOC).

2. Mild steel nail, ∅3 mm, length adjusted such that penetration depth is through cell

3. Propel nail at ≥8 cm/second (Radial penetration selected);

4. An edge cell is selected for the target cell (FIG. 2).

TABLE 8
Time to thermal runaway (voltage definition)
from Nail Penetration (seconds)

| Cell # | 1 | 2 | 3 | 4 | 5 | 6 | 7 |
|---|---|---|---|---|---|---|---|
| Control | 0 | 0.2 | 1.1 | 1.6 | 2.2 | 2.8 | 3.3 |
| Housing | 0 | 0.2 | 0.8 | 2.9 | 17.3 | 140 | 209.5 |
| CE-1 | | | | | | | |
| Housing 7 | 0 | 0.2 | 1.2 | 3.4 | 149.4 | 193.5 | 326.2 |

The results illustrate that that the housing (made from sample 7 material) under the scope of the present disclosure delays thermal runaway by greater than 50% compared to the comparative example.

### Thermal Properties

The thermal properties of a 1.01 mm thick segment of sample 7 were determined over a temperature range of −40 to 85° C. The thermal properties (specific heat, diffusivity and conductivity) of the sample were determined using a NETZSCH LFA 467 HyperFlash™ instrument in accordance with ASTM E1461. The results are provided in Table 9 below:

TABLE 9
Thermal properties

| Temperature | Specific heat | Diffusivity | Conductivity |
|---|---|---|---|
| (° C.) | Cp (J/g-K) | α (mm²/s) | λ (W/m-K) |
| −40 | 0.897 | 1.66 | 2.61 |
| 0 | 1.07 | 1.30 | 2.43 |
| 40 | 1.23 | 1.06 | 2.28 |
| 85 | 1.33 | 8.98 | 2.10 |

Many variants, product forms, uses, and applications of the present disclosure will be apparent to the person skilled in the art and are intended to be encompassed by this disclosure.

1. A freestanding shaped article for an energy storage device comprising greater than 60.0 wt % of an inorganic endothermic material and having an open porosity of greater than 10% v/v and less than 60% v/v, wherein the inorganic endothermic material comprises particles of inorganic endothermic material coated with a carbonaceous binder.

2. The article according to claim 1, wherein the carbonaceous binder comprises at least 1.0 atomic % carbonyl groups.

3. The article according to claim 1, wherein the carbonaceous binder comprises an atomic ratio of oxygen to carbon of at least 1:15.

4. The article according to claim 1, wherein the carbonaceous binder does not have a melting point or has a melting point above an onset decomposition temperature of the endothermic material.

5. The article according to claim 1, wherein the article comprises at least 95 wt % inorganic endothermic material, and the inorganic endothermic material density is greater than 60% and less than 90% of a theoretical maximum density of the endothermic material.

6. The article according to claim 1, wherein the article has an open porosity in the range of 20% to 60% v/v.

7. The article according to claim 1, wherein the inorganic endothermic material density of the article is in a range of 60% to 80% of the maximum theoretical density of the inorganic endothermic material.

8. The article according to claim 1, wherein the article comprises at least 90 wt % of inorganic endothermic material.

9. The article according to claim 1, wherein the inorganic endothermic material comprises particles with a bimodal particle size distribution.

10. The article according to claim 9, wherein peaks of the bimodal distribution are between 30 and 200 microns apart.

11. The article according to claim 1, wherein the binder loading is no more than 1 g per 20 m² of surface area of the endothermic material particles.

12. The article according to claim 1, wherein the article does not deform greater than 5% of an original dimension of the article when subjected to a pressure of 74.4 kPa over a temperature range of room temperature to 500° C.

13. The article according to claim 1, wherein a modulus of rupture is at least 400 psi measured in accordance to ASTM C203 Method I.

14. The article according to claim 1, wherein the article has a moisture weight gain of less than 5 wt % when tested in accordance to ISO 1716 standards.

15. The article according to claim 1, wherein the article is a housing comprising a plurality of recesses shaped to receive a plurality of electrochemical cells.

16. The article according to claim 1, wherein the article has a thermal conductivity (measured at 40° C.) of less than 5.0 W/m·K.

17. A process for the production of a freestanding shaped article, the process comprising:
(a) mixing together a formulation comprising:
(i) particles of an inorganic endothermic material;
(ii) a fugitive thermoplastic binder with a melting point below an endothermic decomposition temperature of the inorganic endothermic material; and optionally
(iii) one or more additives
to form a mixture;
(b) heating the mixture above the melting point of the thermoplastic binder and below the endothermic decomposition temperature of the inorganic endothermic material;
(c) shaping the mixture into a shaped article; and
(d) removing at least part of the thermoplastic binder from the shaped article to leave a carbonaceous binder coating the particles of inorganic endothermic material.

18. The process according to claim 17, wherein the carbonaceous binder comprises products resulting from decomposition or crosslinking of the thermoplastic binder, the optional additives, or both.

19. The process according to claim 17, wherein the thermoplastic binder is removed at a temperature above the melting point of the thermoplastic binder and below the endothermic decomposition temperature of the inorganic endothermic material.

20. The process according to claim 18, wherein the process of removing part of the thermoplastic binder results in decomposition of the thermoplastic binder.

21. The process according to claim 18, wherein the thermoplastic binder is removed at a temperature at or above the decomposition temperature of the thermoplastic binder.

22. The process according to claim 17, wherein the thermoplastic binder comprises a polymer or wax and has a melting point in the range of 30° C. to 100° C.

23. The process according to claim 17, wherein the one or more additives comprise a surfactant.

24. The process according to claim 23, wherein the surfactant comprises a carbonyl group.

25. The process according to claim 23, wherein the formulation comprises between 10 wt % and 30 wt % surfactant relative to the thermoplastic binder.

26. The process according to claim 21, wherein the surfactant comprises or consists of a fatty acid.

27. The process according to claim 17, wherein the thermoplastic binder and additives comprise a paraffin wax and a fatty acid.
